(19) United States
(12) Patent Application Publication
(10) Pub. No.: US 2012/0094548 A1
(43) Pub. Date: Apr. 19, 2012

(54) ELECTRICAL CONNECTOR

(76) Inventor: ROBERT LUMPKINS, Asbury Park, NJ (US)

(21) Appl. No.: 12/904,486

(22) Filed: Oct. 14, 2010

(51) Int. Cl. H01R 4/34

(52) U.S. Cl. 439/801

(57) ABSTRACT

An electrical connector for connecting a battery to a regulator may comprise a first electrical terminal, a second electrical terminal, and a body that is operably coupled to the first electrical terminal and the second electrical terminal for carrying current between the first electrical terminal and the second electrical terminal.

### BACKGROUND OF THE INVENTION

The present invention generally relates to electrical systems, and more specifically relates to an electrical connector.

Modern battery charging systems in the engines of automobiles, boats, motorcycles, and other vehicles generally include an alternator, a voltage regulator, and a battery. As the engine runs, the alternator may generate current for charging the battery. The voltage regulator regulates the charging voltage produced by the alternator, such as by keeping the charging voltage constant in order to protect electrical components on a vehicle.

During the course of operating a vehicle, the voltage regulator may sometimes need to be replaced. However, the process of replacing the voltage regulator may often be a cumbersome and expensive process.

### SUMMARY OF THE INVENTION

In one aspect of the present invention, an electrical connector for connecting a battery to a regulator comprises a first electrical terminal, a second electrical terminal, and a body that is operably coupled to the first electrical terminal and the second electrical terminal for carrying current between the first electrical terminal and the second electrical terminal.

In another aspect of the present invention, a method for connecting a voltage regulator with a battery comprises connecting a battery wire connected to the battery to a first electrical terminal on an electrical connector and connecting a regulator wire connected to the voltage regulator to a second electrical terminal on the electrical connector. A body of the electrical connector is operably coupled to the first electrical terminal and the second electrical terminal for carrying current between the first electrical terminal and the second electrical terminal.

These and other features, aspects and advantages of the present invention will become better understood with reference to the following drawings, description and claims.

### BRIEF DESCRIPTION OF THE DRAWINGS

FIG. 1 shows a perspective view of an electrical connector in use in accordance with an embodiment of the present invention;

FIG. 2 shows an exploded perspective view of the electrical connector of FIG. 1;

FIG. 3 shows a plan view of the electrical connector of FIG. 1;

FIG. 4 shows a front/rear elevation view of the electrical connector of FIG. 1;

FIG. 5 shows a side elevation view of the electrical connector of FIG. 1;

FIG. 6 shows a bottom view of the electrical connector of FIG. 1; and

FIG. 7 shows a section view of the electrical connector of FIG. 1 taken along line 7-7 in FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide an electrical connector that may be used in a vehicle engine system to connect a battery and/or starter to a voltage regulator. The electrical connector may facilitate the task of replacing the voltage regulator. The electrical connector may also help to generally improve the electrical charging system of a vehicle, such as by preventing the alternator, voltage regulator, and generator from breaking or wearing out, and by helping to lengthen the life of the battery.

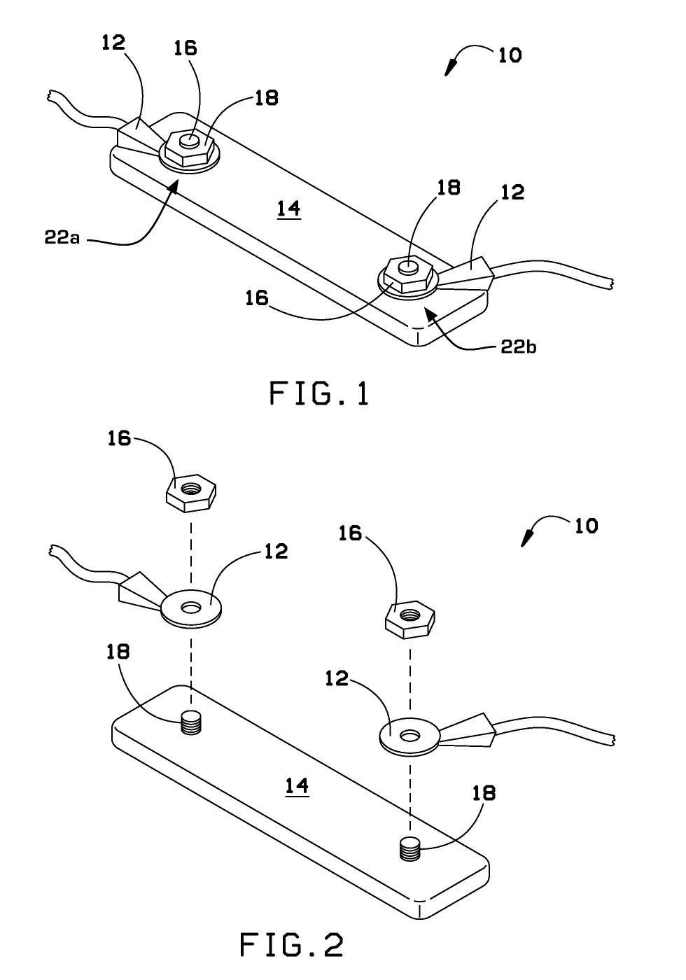

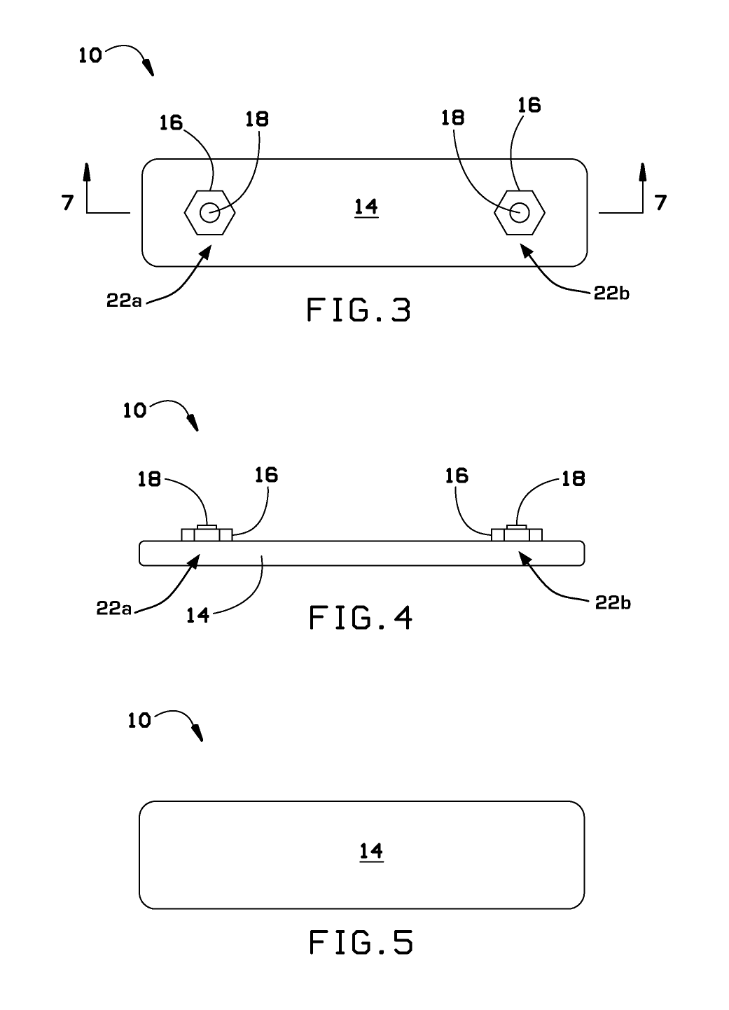

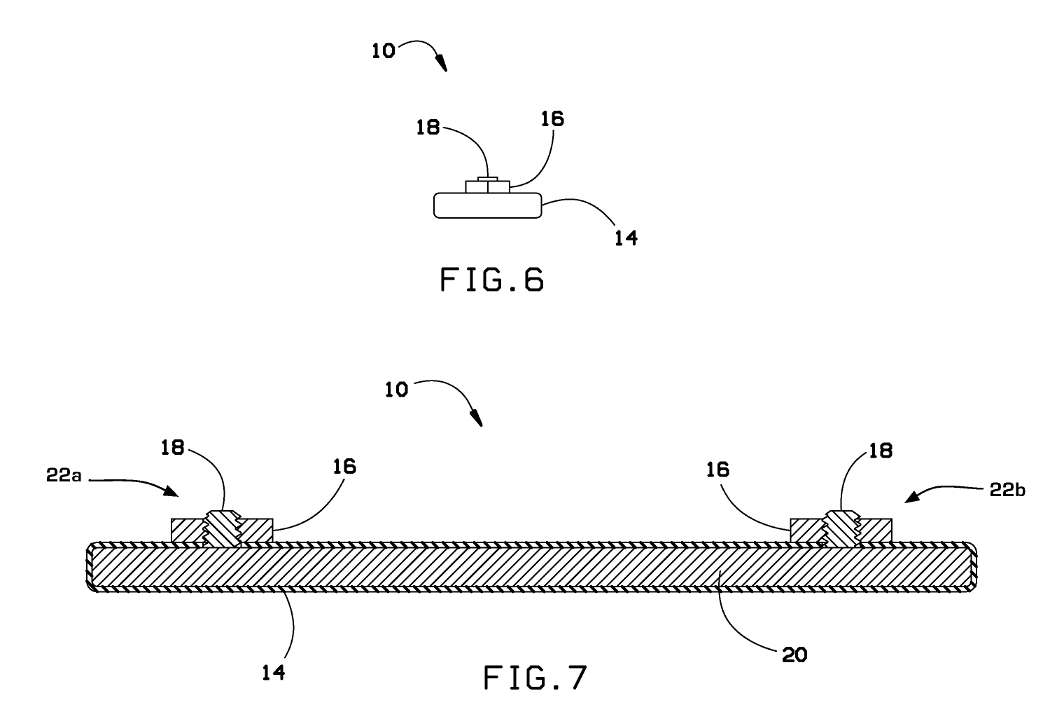

With reference to FIGS. 1-7, an electrical connector 10 may be a device comprising a first electrical terminal 22a and a second electrical terminal 22b that may connect to cable terminal lugs 12 or portions of uninsulated wire or cable, so that current may be conducted between the cables connected to the terminal lugs 12 and the first and second electrical terminals 22a and 22b.

The first and second electrical terminals 22a and 22b may be first and second screw terminals, respectively, with the first and second electrical terminals 22a and 22b each comprising a threaded contact 16 and a nut 18, such as a hex nut, that may be threaded onto the threaded contact 16. In an exemplary embodiment, the terminal lugs 12 may be placed so that they contact the threaded contact 16 and may be secured to the threaded contact 16 by the nut 18.

The electrical connector 10 may further include a body 20 operably coupled to the first electrical terminal 22a and the second electrical terminal 22b for carrying current between the first electrical terminal 22a and the second electric terminal 22b. The body 20 may be any material that may allow current to freely travel between the first and second electrical terminals 22a and 22b. In an exemplary embodiment, the body 20 may be made of a non-corrosive metal, such as a copper plate that may be about two inches in length and one and a half inch in width.

An insulating cover or coating 14, such as a rubber case, may cover at least a portion of the body 20. The insulating cover or coating 14 may help to prevent a user from being electrically shocked when handling the body 20 of the electrical connector 10.

In accordance with an embodiment of the present invention, the electrical connector 10 may be used to connect a battery or an ignition to a voltage regulator in a vehicle, such as in an automobile, motorcycle, boat, or any other vehicle. The battery may originally be connected to the voltage regulator directly with a wire. In that case, the wire may be cut to form two disconnected wires: a battery wire connected to the battery and a regulator wire connected to the voltage regulator. Wire insulators at the ends of the battery wire and the regulator wire may be stripped to expose the uninsulated wire underneath, and terminal lugs 12 may be crimped to the uninsulated ends of the battery wire and the regulator wire.

The battery wire may be connected to the first electrical terminal 22a, while the regulator wire may be connected to the second electrical terminal 22b. The second electrical terminal 22b may receive a current from the voltage regulator via the connected regulator wire. The body 20 of the electrical connector 10 may carry the current to the first electrical terminal 22a, and that current may flow from the first electrical terminal 22a to the battery through the connected battery wire.

To replace the voltage regulator, the regulator wire may be disconnected from the second electrical terminal 22b and the voltage regulator may be removed. A replacement voltage regulator attached to a replacement regulator wire may be installed. If needed, the wire insulator at the end of the replacement regulator wire may be stripped so that a terminal lug 12 may be crimped to the uninsulated end of the replacement regulator wire. The replacement regulator may be connected to the second electrical terminal 22b to output an appropriate current to the battery through the electrical connector 10.

It should be understood, of course, that the foregoing relates to exemplary embodiments of the invention and that modifications may be made without departing from the spirit and scope of the invention as set forth in the following claims.

We claim:

1. An electrical connector for connecting a battery to a regulator, comprising:
a first electrical terminal;
a second electrical terminal; and
a body that is operably coupled to the first electrical terminal and the second electrical terminal for carrying current between the first electrical terminal and the second electrical terminal.

2. The electrical connector of claim 1, wherein the first electrical terminal is a first screw terminal and the second electrical terminal is a second screw terminal.

3. The electrical connector of claim 2, wherein the first screw terminal comprises a first threaded contact and a first nut and the second screw terminal comprises a second threaded contact and a second nut.

4. The electrical connector of claim 1, wherein the body comprises a metal plate.

5. The electrical connector of claim 4, wherein the body comprises a copper plate.

6. The electrical connector of claim 1, further comprising:
an insulating cover that covers at least a portion of the body.

7. The electrical connector of claim 6, wherein the insulating cover comprises a rubber casing.

8. A method for connecting a voltage regulator with a battery, the method comprising:
connecting a battery wire connected to the battery to a first electrical terminal on an electrical connector; and
connecting a regulator wire connected to the voltage regulator to a second electrical terminal on the electrical connector;
wherein a body of the electrical connector is operably coupled to the first electrical terminal and the second electrical terminal for carrying current between the first electrical terminal and the second electrical terminal.

9. The method of claim 8, further comprising:
disconnecting the regulator wire from the second electrical terminal.

10. The method of claim 9, further comprising:
connecting a replacement regulator wire connected to a replacement voltage regulator to the second electrical terminal.
